(19) United States
(12) Patent Application Publication
(10) Pub. No.: US 2026/0122553 A1
(43) Pub. Date: Apr. 30, 2026

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Haorui YANG, Dongguan (CN); Fei LU, Dongguan (CN)

(73) Assignee: GUANGDONG OPPO MOBILE TELECOMMUNICATIONS CORP., LTD., Dongguan (CN)

(21) Appl. No.: 19/003,214

(22) Filed: Dec. 27, 2024

Related U.S. Application Data
(63) Continuation of application No. PCT/CN2022/108898, filed on Jul. 29, 2022.

(51) Int. Cl. H04W 48/08

(52) U.S. Cl. CPC H04W 48/08

(57) ABSTRACT

A communication method and a communications apparatus are provided. The method includes: receiving, by a first device, a trigger signal transmitted by a second device; and transmitting, by the first device, a response signal to the trigger signal to the second device, where the first device is a zero-power terminal device, and the second device is a network device or a proxy terminal device.

This application is a continuation of International Application No. PCT/CN2022/108898, filed on Jul. 29, 2022, the disclosure of which is hereby incorporated by reference in its entirety.

### TECHNICAL FIELD

This application relates to the field of communications technologies, and more specifically, to a communication method and a communications apparatus.

### BACKGROUND

With development of communications technologies, zero-power terminals are put into use in some communications systems, and the zero-power terminals have features such as low power consumption and low costs. However, because zero-power terminals have relatively simple designs, which may cause some problems in use.

### SUMMARY

Embodiments of this application provide a communication method and a communications apparatus. The following describes various aspects involved in embodiments of this application.

According to a first aspect, a communication method is provided, where the method includes: receiving, by a first device, a trigger signal transmitted by a second device; and transmitting, by the first device, a response signal to the trigger signal to the second device, where the first device is a zero-power terminal device, and the second device is a network device or a proxy terminal device.

According to a second aspect, a communication method is provided, where the method includes: transmitting, by a second device, a trigger signal; and receiving, by the second device, a response signal to the trigger signal transmitted by the first device, where the first device is a zero-power terminal device, and the second device is a network device or a proxy terminal device.

According to a third aspect, a communications apparatus is provided, where the apparatus includes: a receiving unit, configured to receive a trigger signal transmitted by a second device; and a transmitting unit, configured to transmit a response signal to the trigger signal to the second device, where the apparatus is a zero-power terminal device, and the second device is a network device or a proxy terminal device.

According to a fourth aspect, a communications apparatus is provided, where the apparatus includes: a transmitting unit, configured to transmit a trigger signal; and a receiving unit, configured to receive a response signal to the trigger signal transmitted by the first device, where the first device is a zero-power terminal device, and the apparatus is a network device or a proxy terminal device.

According to a fifth aspect, a communications apparatus is provided, and the communications apparatus includes a memory, a transceiver, and a calculation module. The memory is configured to store a program, the transceiver is configured to perform data transmission and reception, and the calculation module is configured to invoke the program in the memory to execute the method according to the first aspect.

The calculation module may provide a calculation function, for example, may be a processor. The calculation module may alternatively provide a calculation function required by a zero-power terminal device, for example, may be a low-power calculation module in the zero-power terminal device.

According to a sixth aspect, a communications apparatus is provided, and the communications apparatus includes a memory, a transceiver, and a processor. The memory is configured to store a program, the transceiver is configured to perform data transmission and reception, and the processor is configured to invoke the program in the memory to execute the method according to the second aspect.

According to a seventh aspect, a communications apparatus is provided, including a calculation module, configured to invoke a program from a memory to execute the method according to the first aspect.

The calculation module may provide a calculation function, for example, may be a processor. The calculation module may alternatively provide a calculation function required by a zero-power terminal device, for example, may be a low-power calculation module in the zero-power terminal device.

According to an eighth aspect, a communications apparatus is provided, including a processor, configured to invoke a program from a memory to execute the method according to the second aspect.

According to a ninth aspect, a chip is provided, including a processor, configured to invoke a program from a memory to cause a device installed with the chip to perform the method according to the first aspect.

According to a tenth aspect, a chip is provided, including a processor, configured to invoke a program from a memory to cause a device installed with the chip to perform the method according to the second aspect.

According to an eleventh aspect, a computer-readable storage medium is provided, where a program is stored on the computer-readable storage medium, and the program causes a computer to execute the method according to the first aspect.

According to a twelfth aspect, a computer-readable storage medium is provided, where a program is stored on the computer-readable storage medium, and the program causes a computer to execute the method according to the second aspect.

According to a thirteenth aspect, a computer program product is provided, including a program, where the program causes a computer to execute the method according to the first aspect.

According to a fourteenth aspect, a computer program product is provided, including a program, where the program causes a computer to execute the method according to the second aspect.

According to a fifteenth aspect, a computer program is provided, where the computer program causes a computer to execute the method according to the first aspect.

According to a sixteenth aspect, a computer program is provided, where the computer program causes a computer to execute the method according to the second aspect.

### BRIEF DESCRIPTION OF DRAWINGS

FIG. 1 is an example diagram of a wireless communications system to which an embodiment of this application is applicable.

FIG. 2 is an example diagram of zero-power communication according to an embodiment of this application.

FIG. 3 is an example diagram of backscatter communication according to an embodiment of this application.

FIG. 4 is an example diagram of energy harvesting according to an embodiment of this application.

FIG. 5 is an example diagram of resistive load modulation according to an embodiment of this application.

FIG. 6 is an example diagram of a wireless communications system to which an embodiment of this application is applicable.

FIG. 7 is a schematic flowchart of a communication method according to an embodiment of this application.

FIG. 8 is a schematic flowchart of a communication method according to another embodiment of this application.

FIG. 9 is a schematic flowchart of a communication method according to a yet another embodiment of this application.

FIG. 10 is a schematic flowchart of a communication method according to a still another embodiment of this application.

FIG. 11 is a schematic structural diagram of a communications apparatus according to an embodiment of this application.

FIG. 12 is a schematic structural diagram of a communications apparatus according to another embodiment of this application.

FIG. 13 is a schematic structural diagram of an apparatus according to an embodiment of this application.

### DESCRIPTION OF EMBODIMENTS

Technical solutions in this application are described below with reference to the accompanying drawings.

With development of wireless communications technologies, it is desirable to integrate a wireless communications system with various vertical industries such as logistics, manufacturing, transportation, and energy. For example, the wireless communications system may be integrated with an industrial wireless sensor network (IWSN). For another example, the wireless communications system may be integrated with a smart logistics and smart warehousing. For another example, the wireless communications system may be integrated with an intelligent home network.

However, in these industries, a terminal device is generally required to have features such as relatively low costs, a relatively small size (such as an ultra-thin size), maintenance-free, and long life. Therefore, to meet the foregoing condition, communication may be performed between a network device and a terminal device by using a zero-power communication technology. In this case, the terminal device may also be referred to as a “zero-power terminal device” or “zero-power device”.

The zero-power communications technology and a zero-power terminal device are described below with reference to FIG. 1 to FIG. 5. FIG. 1 shows an architecture of a zero-power communications system 100 to which an embodiment of this application is applied. The architecture shown in FIG. 1 includes a network device 110 and a terminal device 120. The network device 110 may be a device that communicates with the terminal device 120. The network device 110 may provide communication coverage for a specific geographic area, and may communicate with a terminal device 120 located within the coverage.

The network device 110 and the terminal device 120 may communicate based on a backscatter (back scattering) communication technology. In the backscatter communication technology, a signal used for backscatter communication is crucial. The signal used for backscatter communication is a radio signal, such as a radio frequency signal. The signal used for backscatter communication may include, for example, an energy supply signal, a carrier signal, and the like. In some embodiments, the network device 110 may transmit an energy supply signal to the terminal device 120 to supply energy to the terminal device. In some other embodiments, the terminal device 120 may transmit data to the network device 110 by using a carrier signal. In some implementations, the energy supply signal may further carry data or control information transmitted by the network device 110 to the terminal device 120. Optionally, the energy supply signal may be used only for energy supply, which is not limited in embodiments of this application.

It should be noted that FIG. 1 exemplarily shows one network device and one terminal device. Optionally, the communications system 100 may include a plurality of network devices, and another quantity of terminal devices may be included within coverage of each network device, which is not limited in embodiments of this application.

In addition, in some implementations, the communications system 100 may further include another network entity such as a network controller or a mobility management entity. This is not limited in embodiments of this application.

It should be understood that the technical solutions in embodiments of this application may be applied to various communications systems, such as a 5th generation (5G) system or new radio (NR), a long term evolution (LTE) system, an LTE frequency division duplex (FDD) system, LTE time division duplex (TDD), and a cellular Internet of Things. The technical solutions provided in this application may be further applied to a future communications system, for example, a 6th generation mobile communications system.

The terminal device in embodiments of this application may also be referred to as user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may refer to a device providing a user with voice and/or data connectivity and capable of connecting people, objects, and machines, such as a handheld device, a vehicle-mounted device, a home appliance, a sensor, or an electronic tag that has a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. All terminal devices in embodiments of this application may be zero-power terminals.

The network device in embodiments of this application may be a device used to communicate with a terminal device. If the terminal device is an electronic tag, the network device may be a reader/writer (for example, a reader/writer based on a radio frequency identification (RFID) technology) that is configured to read or write the electronic tag. The network device may alternatively be an access network device or a radio access network device. For example, the network device may be a base station. The network device in embodiments of this application may be a radio access network (RAN) node (or device) that connects the terminal device to a wireless network. The base station may broadly cover various names in the following, or may be replaced with a name in the following, for example, a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device (D2D), vehicle-to-everything (V2X), or machine-to-machine (M2M) communication, a network-side device in a 6G network, a device that functions as a base station in a future communications system, or the like. The base station may support networks with a same access technology or different access technologies. A specific technology and specific device form used by the network device are not limited in embodiments of this application.

The base station may be a fixed or mobile station. For example, a helicopter or an unmanned aerial vehicle may be configured to function as a mobile base station, and one or more cells may move depending on a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario of the network device and the terminal device is not limited.

It should be understood that all or some of functions of a communications device in this application may also be implemented by software functions running on hardware, or by virtualization functions instantiated on a platform (for example, a cloud platform).

For ease of understanding of the zero-power communications technology, the following describes a terminal device that supports the zero-power communications technology with reference to FIG. 2.

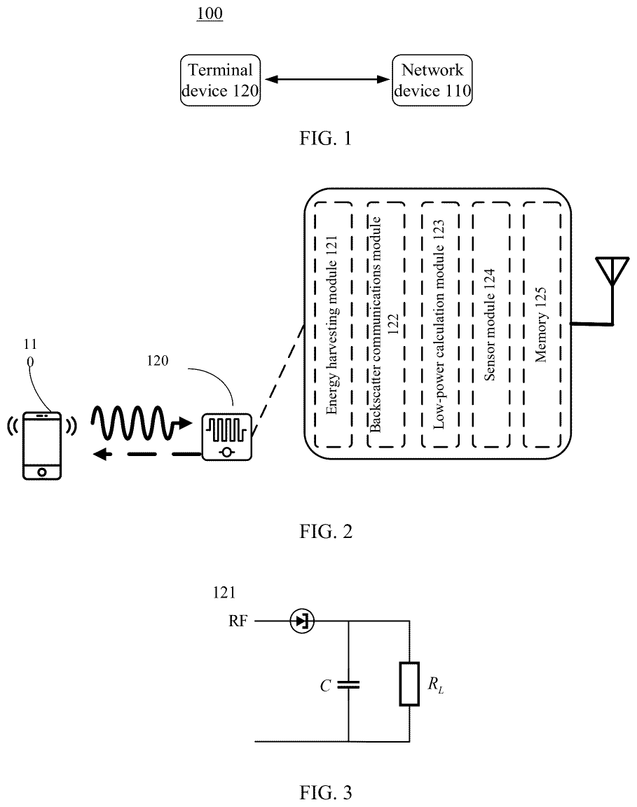

Generally, the terminal device 120 may include an energy harvesting module 121 and a backscatter communications module 122. The energy harvesting module 121 and the backscatter communications module 122 are described below with reference to FIG. 3 to FIG. 5. For brevity, details are not described herein again. In some cases, the terminal device 120 may further include a low-power calculation module 123. The low-power calculation module 123 is configured to provide a calculation function, such as data processing, for the terminal device 120. In some other cases, the terminal device 120 may further include a sensor 124 configured to collect external information (for example, an ambient temperature and ambient humidity). In some other cases, the terminal device 120 may further include a memory 125 configured to store some information (such as external information collected by using the foregoing sensor, or an object identity).

The energy harvesting module 121 is configured to harvest energy. In some implementations, energy may be harvested by using an energy supply signal transmitted by the network device. The energy supply signal may be a “radio frequency signal” transmitted by the network device. Therefore, the energy harvesting module is also referred to as a “radio frequency energy harvesting module”.

FIG. 3 shows a possible structure of an energy harvesting module. As shown in FIG. 3, the energy harvesting module 121 may harvest energy of a spatial electromagnetic wave of a radio frequency signal based on an electromagnetic induction principle, and store harvested energy in a capacitor C, which is a process of charging the capacitor C. After the process of charging the capacitor C is ended, the capacitor C may start to discharge, to supply energy to the terminal device for operation. For example, the discharging of the capacitor C may be used to drive the terminal device to perform low power demodulation on data transmitted by the network device. For another example, the discharging of the capacitor C may be used to drive the terminal to modulate data to be transmitted. For another example, the discharging of the capacitor C may be used to drive a sensor of the terminal device to collect data. For another example, the discharging of the capacitor C may be used to drive the terminal devices to read data in the memory 125 or the like.

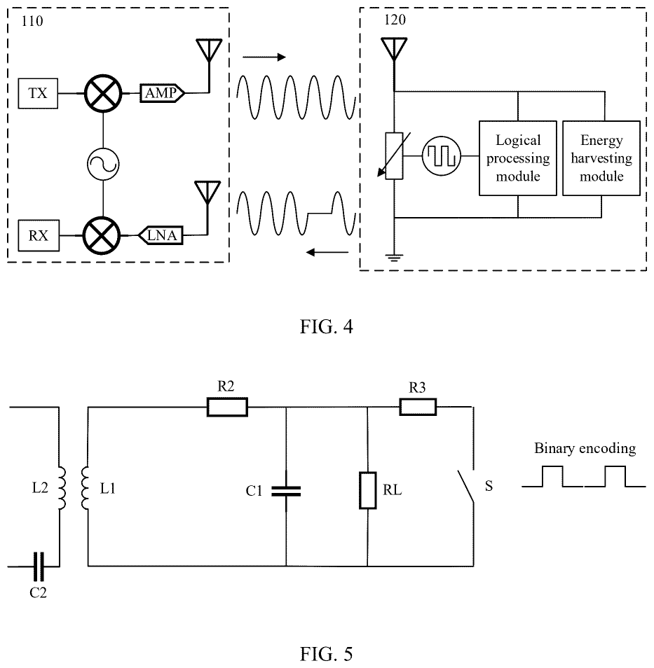

The backscatter communications module 122 is configured for the terminal device 120 to perform backscatter communication with the network device 110. A backscatter communication principle according to an embodiment of this application is described below with reference to FIG. 4. Referring to FIG. 4, the terminal device 120 receives a radio signal transmitted by the network device 110, and modulates the radio signal to load data to be transmitted. Finally, the modulated signal is radiated from an antenna. This information transmission process is referred to as backscatter communication. The foregoing radio signal may also be referred to as a carrier signal. The carrier signal may be a radio signal that is not modulated. The carrier signal may be, for example, a sine wave signal. Backscatter communication is highly related to a load modulation function. The load modulation function may be understood as that a circuit parameter of an oscillation loop of the terminal device is adjusted and controlled according to a beat of a data stream, such that a parameter such as a magnitude of impedance of the terminal device changes accordingly, thereby completing a modulation process.

In some implementations, another component, for example, an amplifier (amplifier, AMP), may further be disposed on a transport (TX) path of the network device 110, to process a signal to be transmitted. Another component, for example, a low noise amplifier (LNA), may further be disposed on a receive (RX) path of the network device 110, to process a received signal.

In some other implementations, the terminal device 120 may include an energy harvesting module, and the energy harvesting module may be configured to collect any signal in an environment. For example, the energy harvesting module may be configured to harvest energy of an energy supply signal transmitted by a network device. A form of the energy supply signal is not specifically limited in embodiments of this application. For example, the energy supply signal may be a modulated radio signal, or may be an unmodulated radio signal. The carrier signal described above may also be used as the energy supply signal. For another example, the energy supply signal may alternatively be a wireless signal of any waveform, such as a sine wave or a square wave.

Optionally, a logic processing module may be further disposed in the terminal device 120, to execute a corresponding calculation function.

It should be noted that, for both the network device 110 and the terminal device 120, FIG. 4 only exemplarily shows a connection structure of a signal processing circuit, and processing circuits of the network device 110 and/or the terminal device 120 may include other elements. This is not specifically limited in embodiments of this application.

Generally, a load modulation function may be implemented in two manners: resistive load modulation and capacitive load modulation. FIG. 5 is a circuit diagram of a terminal device based on a resistive load modulation technology. It should be noted that the circuit illustrated in FIG. 5 that implements a load modulation technology is similar to an existing circuit implementing a load modulation technology. For brevity, details of functions of resistors R2 and R3, capacitors C1 and C2, and inductors L1 and L2 included in the circuit in FIG. 5 are not described.

In the resistive load modulation, a resistor RL may be connected in parallel to a load. A switch S may control on/off of the resistor RL under control of a binary data stream. In this way, on/off of the resistor RL causes a change in a voltage of the circuit, and amplitude of a backscatter signal from the terminal device may be controlled by the change in the voltage of the circuit, so as to implement modulation of the backscatter signal, that is, implement amplitude-shift keying (ASK) modulation on the backscatter signal.

Similarly, in the capacitive load modulation, on/off of the capacitor may be controlled based on a binary data stream, to change a resonance frequency of a circuit, thereby changing an operating frequency of the backscatter signal. In this case, frequency-shift keying (FSK) modulation is implemented.

As described above, the terminal device may perform information modulation on a received signal (namely, a carrier signal) through load modulation, to implement a backscatter communication process. Therefore, a terminal device in backscatter communication generally has the following advantages.
Advantage 1: Since the terminal device does not need to actively transmit a signal, no complex radio frequency path is required to be constructed. For example, a component such as a power amplifier (PA) or a radio frequency filter may not be disposed on the radio frequency path, so that costs and a volume of the terminal are reduced.
Advantage 2: Since the terminal device is not required to actively generate a high-frequency signal, there is no need for a high-frequency crystal oscillator, so that costs and a volume of the terminal device are reduced.
Advantage 3: Since the terminal device may communicate with the network device by using the backscatter technology, less energy is consumed by the terminal device during communication, or even no energy of the terminal device is consumed.

In addition to the backscatter communication, energy harvesting, and load modulation functions described above, the terminal device may further have a coding function. For data transmitted by an encoding end (such as a terminal device or an electronic tag), different forms of code may be used to represent binary bits “1” and “0”. In a zero-power communications system, a common coding manner may include: non-return-to-zero inverted (NRZ) encoding, Manchester encoding, unipolar return-to-zero (Unipolar RZ) encoding, differential bi-phase (DBP) encoding, Miller encoding, differential encoding, or the like. Generally speaking, the encoding process is to represent 0 and 1 by using different pulse signals.

Based on the foregoing description of the zero-power communication technology, it may be learned that, a terminal device in zero-power communication (also referred to as a “zero-power terminal”) consumes little energy of the terminal device for communication, or may even consume no energy of the terminal device. Therefore, in the zero-power communication technology, based on energy sources and energy use manners of terminal devices, the terminal devices may be classified into three types: a passive zero-power terminal, a semi-passive zero-power terminal, and an active zero-power terminal.

### I. Passive Zero-Power Terminal

The passive zero-power terminal generally does not need a built-in battery. When the terminal device approaches a network device, the terminal device is within a near field range formed by radiation of an antenna of the network device. In this case, the antenna of the terminal device may generate an induced current through electromagnetic induction, and the induced current may supply energy to the terminal device, to implement demodulation of a signal on forward link (namely, a received signal) and/or modulation and encoding of a signal on backward link (namely, a signal to be transmitted) and the like. The forward link may be a link of transmission from the network device to the terminal device, or may be referred to as a downlink. The backward link may be a link of transmission from the terminal device to the network device, or may be referred to as an uplink. The zero-power terminal transmits a signal on the backward link in a backscatter implementation manner. Therefore, for the zero-power terminal device, the backward link may also be referred to as a backscatter link.

In some implementations, the passive zero-power terminal may be an electronic tag. Accordingly, the network device may be a reader/writer in a radio frequency identification (RFID) system, and is configured to read content in the electronic tag and/or is configured to change the content in the electronic tag.

### II. Semi-Passive Zero-Power Terminal

No conventional battery is installed in the semi-passive zero-power terminal, but radio wave energy may be harvested by using the energy harvesting module 121, and the harvested energy may be stored in an energy storage unit (for example, a capacitor). After obtaining the energy, an energy storage unit may supply energy to the terminal device, to implement demodulation of a signal on forward link (namely, a received signal) and/or modulation and encoding of a signal on backward link (namely, a signal to be transmitted), and the like.

### III. Active Zero-Power Terminal

A battery may be built in the active zero-power terminal. The battery may supply energy to the terminal device, to implement demodulation of a signal on forward link (namely, a received signal) and/or modulation and encoding of a signal on backward link (namely, a signal to be transmitted), and the like. However, when the terminal device performs signal communication on a backscatter link, the terminal device does not need to consume energy of the battery. Therefore, for such terminal device, “zero power” is mainly reflected in a scenario in which the terminal device performs communication by using the backscatter technology.

In some implementations, the foregoing active zero-power terminal may be an electronic tag, and the network device may be an RFID reader/writer. In this case, the built-in battery may supply power to an RFID chip in the terminal device, to increase a read/write distance between the RFID reader and the electronic tag. In addition, the built-in battery may supply power to the RFID chip in the terminal device, to shorten a read/write delay of the RFID reader/writer for the electronic tag, thereby improving communication reliability.

A zero-power terminal in embodiments of this application has features such as low complexity, supporting environmental energy supply, backscatter, and a new waveform. The name of the zero-power terminal in embodiments of this application does not constitute a limitation on an energy source and an energy usage manner of the terminal, provided that energy required for operation of the terminal mainly comes from an external environment. In this case, the terminal device may be a zero-power device or a low power device. In some embodiments, the zero-power terminal may also be referred to as an environmental energy supplied terminal, an energy harvesting-based terminal, or the like.

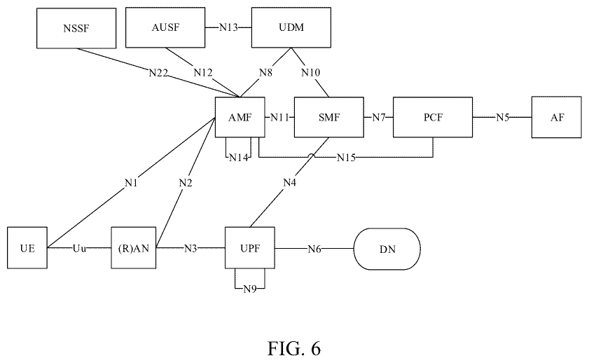

FIG. 6 is a diagram of a system architecture of a 5G network. As shown in FIG. 6, the following describes each network element involved in the system architecture.

1. A (radio) access network ((R)AN) network element is configured to provide a network access function for an authorized user in a specific area, and can use transmission tunnels of different quality according to a user level, a service requirement, or the like. The (R)AN network element can manage a radio resource, and provide an access service for the terminal device, to complete forwarding of a control signal and user data between the terminal device and a core network. The (R)AN network element may be understood as a base station in a traditional network.

2. A user plane network element is configured to perform packet routing and forwarding, a quality of service (QoS) processing of user plane data, and the like.

In a 5G communications system, the user plane network element may be a user plane function (UPF) network element. In a future communications system, the user plane network element may still be a UPF network element, or may have another name, which is not limited in this application.

3. A data network network element is configured to provide a network for transmitting data. In a 5G communications system, the data network element may be a data network (DN) network element. In a future communications system, the data network network element may still be a DN network element, or may have another name, which is not limited in this application.

4. An access management network element is mainly configured for mobility management, access management, and the like, and may be configured to implement functions other than session management in functions of a mobility management entity (MME), such as lawful interception and access authorization or authentication.

In a 5G communications system, the access management network element may be an access and mobility management function (AMF) network element. In a future communications system, the access management network element may still be an AMF network element, or may have another name, which is not limited in this application.

5. A session management network element is mainly configured for session management, internet protocol (IP) address allocation and management for terminal devices, selection of a manageable user plane function, an endpoint for a policy control and charging function interface, downstream data notification, and the like.

In a 5G communications system, the session management network element may be a session management function (SMF) network element. In a future communications system, the session management network element may still be an SMF network element, or may have another name, which is not limited in this application.

6. A policy control network element provides a unified policy framework to guide network behaviors, that is, provides policy rule information and the like for a control plane function network element (such as an AMF or an SMF network element).

In a 5G communications system, the policy control network element may be a policy control function (PCF) network element. In a future communications system, the policy control network element may still be a PCF network element, or may have another name, which is not limited in this application.

7. An authentication service network element is configured to implement user authentication, certification and the like.

In a 5G communications system, the authentication service network element may be an authentication server function (AUSF) network element. In a future communications system, the authentication service network element may still be an AUSF network element, or may have another name, which is not limited in this application.

8. A unified data management network element is configured for user identification handling, access authentication, registration, mobility management, and the like.

In a 5G communications system, the unified data management network element may be a unified data management (UDM) network element. In a future communications system, the unified data management network element may still be a UDM network element, or may have another name, which is not limited in this application.

9. A network slice selection network element is configured to select a set of network slice instances serving a UE, and determine a set of AMFs that may be used to query a UE, or determine a list of candidate AMFs based on a configuration, and the like.

In a 5G communications system, the network slice selection network element may be a network slice selection function (NSSF) network element. In a future communications system, the network slice selection network element may still be an NSSF network element, or may have another name, which is not limited in this application.

10. An application function (AF) refers to various services in an application layer, for example, may be an internal application of an operator such as a voice over long-term evolution (Volte) AF, or may be an AF of a third party (such as a video server or a game server) or the like.

11. A terminal device may include various handheld devices with a wireless communication function, a vehicle-mounted device, a wearable device, a computing device or another processing device connected to a wireless modem, and various forms of terminals, a mobile station (MS), a terminal, a user equipment (UE), a zero-power terminal, and the like, such as a water meter, a meter, and a sensor.

In the network architecture, N1 is a reference point between the UE and the AMF network element, N2 is a reference point between the (R)AN network element and the AMF network element, and is used for transmitting a non-access stratum (NAS) message. N3 is a reference point between the (R)AN network element and the UPF network element, and is used for transmitting user plane data, and the like. N4 is a reference point between the SMF network element and the UPF network element, and is used for transmitting information such as tunnel identifier information for an N3 connection, data cache indication information, and a downlink data notification message. N5 is a reference point between the PCF network element and the AF network element. The N6 interface is a reference point between the UPF network element and the DN network element, and is used for transmitting user plane data, and the like. N9 is a reference point between UPFs and is used to transfer uplink and downlink user data streams between UPFs. N11 is a reference point between the AMF network element and the SMF network element. N8 and N10 are respectively reference points between the AMF network element and the UDM network element, and between the SMF network element and the UDM network element, and are used for acquiring user subscription data. N14 is a reference point between AMF network elements, and is used for reallocating AMFs and information transmission between AMFs. N15 and N7 are respectively reference points between the AMF network element and the PCF network element, and between the SMF network element and the PCF network element, and are used for acquiring policy data. N12 is a reference point between the AMF network element and the AUSF network element. N13 is a reference point between the UDM network element and the AUSF network element. N22 is a reference point between the NSSF network element and the AMF network element.

It should be understood that the foregoing network architecture applied to embodiments of this application is merely an example of a network architecture. A network architecture applicable to embodiments of this application is not limited thereto. Any network architecture that can implement functions of the foregoing network elements is applicable to embodiments of this application.

In the system architecture shown in FIG. 6, the terminal device may directly access a network, or may access a network by using a relay device (for example, a UE in FIG. 6). The former may be referred to as a direct mode, and the latter is referred to as an indirect mode.

In a conventional technology, when the terminal device accesses a network, unified access control (UAC) is required to be performed. Occasions at which the terminal device performs the UAC may include an occasion when the terminal device enters a connected state from an idle state, or an occasion when the terminal device performs the UAC for a specific service in the connected state. In an idle state, an access category (access category, AC) needs to be determined for each service. In a connected state, the UAC is performed only for the following services: an IP multimedia subsystem (IMS) related service, a short messaging service (SMS) based on an NAS, packet data unit (PDU) session establishment, PDU session modification, restart or restoration of user plane resources of a PDU session, and the like.

For example, different ACs correspond to different categories of services, and the NAS layer of the terminal device may determine the AC based on a service for triggering access to a network. After determining the AC, the NAS layer may determine a radio resource control (RRC) establishment cause based on the AC, and transmit an access identity (AI), the AC, and the establishment cause to the RRC layer.

The AI currently supported is shown in the following Table 1, and an AI of the terminal may be written into an SIM card in advance. When UAC is performed, the AI may be read from the SIM card. All current Als are identities of UEs having a high priority, especially AI=1, 2 indicates the highest priority.

TABLE 1
Definition of AI

| AI number | UE configuration |
|---|---|
| 0 | The UE is not configured with an AI. |
| | (UE is not configured with any parameters from this table) |
| 1 (NOTE 1) | The UE is configured with a multimedia priority service. |
| | (UE is configured for multimedia priority service (MPS)) |
| 2 (NOTE 2) | The UE is configured with a critical session service. |
| | (UE is configured for mission critical service (MCS)) |
| 3 (NOTE 4) | The UE is configured with a disaster condition application. |
| | (UE for which a disaster condition applies) |
| 4-10 | Reserved |
| | (Reserved for future use) |
| 11 (NOTE 3) | Access Class 11 is configured in the UE |
| 12 (NOTE 3) | Access Class 12 is configured in the UE |
| 13 (NOTE 3) | Access Class 13 is configured in the UE |
| 14 (NOTE 3) | Access Class 14 is configured in the UE |
| 15 (NOTE 3) | Access Class 15 is configured in the UE |

Next, the RRC layer may determine, based on an access threshold corresponding to an AI and an AC that are broadcast in system information (where each AC corresponds to a respective access threshold), whether or not being allowed to access a network. The RRC layer may generate a random number between 0 and 1. If the random number is less than the access threshold, it indicates that access to the network is allowed. If the random number is greater than the access threshold, it indicates that access to the network is rejected. In this case, a timer (for example, a timer T390) may be started. The timer may be bound to an AC, and access control corresponding to the AC before the timer expires are all determined as failed. The RRC layer may notify the NAS layer of a determining result of the access control.

Currently, a zero-power terminal device may directly access a network in a direct mode, or may indirectly access a network in an indirect mode. However, it is still unclear how to perform access control on the zero-power terminal device.

To solve one or more of the foregoing technical problems, this application provides a communication method and a communications apparatus, which can implement access control of a zero-power terminal device.

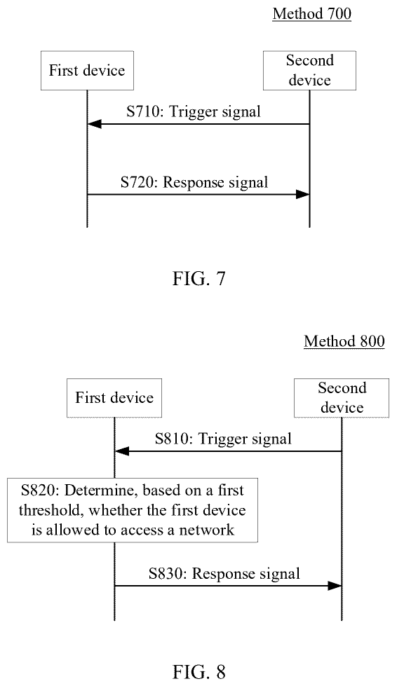

With reference to FIG. 7 to FIG. 10, the following describes embodiments of this application in detail by using examples.

FIG. 7 is a schematic flowchart of a communication method according to an embodiment of this application. The method 700 shown in FIG. 7 may include steps S710 and S720. Details are as follows.

S710: A second device transmits a trigger signal to a first device.

For example, the second device may transmit the trigger signal to the first device by using an RRC layer or an NAS layer.

In embodiments of this application, the first device may be a zero-power terminal device. For example, the first device may be a zero-power terminal device that can perform an ambient IoT (AIoT) service.

In embodiments of this application, the second device may be a network device or a proxy terminal device (proxy UE). The proxy terminal device may also be referred to as a relay terminal device. For example, when the first device accesses a network in a direct mode, the second device may be an RAN (namely, a network device) in FIG. 6. When the first device accesses a network in an indirect mode, the second device may be a UE in FIG. 6. In this case, the UE in FIG. 6 may be a proxy terminal device, and the first device may access a network via the UE.

The trigger signal may be a carrier signal transmitted by the second device, and the first device may perform backscatter communication based on the carrier signal. Optionally, the carrier signal may be an energy supply signal. Alternatively, the trigger signal may include an energy supply signal. For example, an energy harvesting module in the first device may harvest energy in the energy supply signal.

S720: The first device transmits a response signal to the second device.

The response signal may be a response signal to the trigger signal. The first device transmitting a response signal to the second device may refer to that the first device generates a backscatter signal based on the trigger signal, and transmits the backscatter signal to the second device.

Optionally, the first device may perform access control on the first device in combination with the trigger signal and/or the response signal. Alternatively, the first device may perform access control on the first device in combination with transmission processes of the trigger signal and the response signal.

Optionally, the second device may perform access control on the first device in combination with the trigger signal and/or the response signal. Alternatively, the second device may perform access control on the first device in combination with transmission processes of the trigger signal and the response signal.

In embodiments of this application, a first device receives a trigger signal transmitted by a second device, and transmits a response signal to the trigger signal to the second device. The access control of a zero-power terminal device is implemented in combination with transmission processes of the trigger signal and the response signal.

It should be noted that when being allowed to access a network, a common terminal device (a non-zero power UE) is required to initiate random access, to access the network. That is, for a common terminal device, being allowed to access a network may be understood as being allowed to transmit random access. In contrast, a zero-power terminal device does not initiate random access, and the zero-power terminal device may transmit a response signal only when being allowed to access, or a network device or a proxy terminal device may process the response signal only when the zero-power terminal device is allowed to access.

In embodiments of this application, in combination with the transmission process of the trigger signal and the transmission process of the response signal, access control may be performed on a zero-power terminal device in various manners. The following describes in detail with reference to FIG. 8 to FIG. 10.

FIG. 8 is a schematic flowchart of a communication method according to an embodiment of this application. The method 800 shown in FIG. 8 may include steps S810 to S830. Details are as follows.

S810: A second device transmits a trigger signal to a first device.

In this case, the first device may be a zero-power terminal device.

The second device may be a proxy terminal device. The first device may use the second device as a relay device, and access a network by using the second device.

The second device may alternatively be a network device. For example, the second device may be an RAN, an AMF, a PCF, or the like in FIG. 6. The RAN in FIG. 6 may be an eNB, a gNB, a device that functions as a base station in a future communications system, or the like.

S820. The first device determines, based on a first threshold, whether the first device is allowed to access a network.

In some possible implementations, the first threshold may be determined based on a trigger signal. For example, the first threshold may be 0.3.

The trigger signal may include the first threshold. Optionally, the first threshold may be for all services. For example, the first threshold may correspond to all services of a zero-power terminal device (In other words, for all services of the zero-power terminal device, values of the first threshold are the same).

The trigger signal may include a mapping relationship between the first threshold and a service. For example, n access thresholds may be in a one-to-one correspondence with n services, and the trigger signal may include a correspondence between the n access thresholds and the n services, where n is a positive integer. The mapping relationship may be configured by a core network for the second device. For example, when the second device is a network device, the AMF may configure a mapping relationship between a first threshold and a service to the network device. When the second device is a proxy terminal device, the AMF or the PCF may configure the mapping relationship between the first threshold and the service to the proxy terminal device. Specifically, the AMF or the PCF may transmit the mapping relationship to the proxy terminal device via an NAS layer.

Alternatively, the mapping relationship between the first threshold and a service may be preset. The trigger signal may not include the mapping relationship between the first threshold and a service. For example, a correspondence between n access thresholds and n services may be preset in a communication protocol.

Correspondingly, before S820, the first device may determine the first threshold based on a service corresponding to the first device and the mapping relationship. The service corresponding to the first device may refer to a service carried in the trigger signal and used for triggering an NAS layer of the first device to perform UAC.

In some possible implementations, the first threshold may be determined based on broadcast information. Correspondingly, before S820, the second device may transmit the broadcast information to the first device.

Similarly, the broadcast information may include the first threshold. Alternatively, the broadcast information may include the mapping relationship between the first threshold and a service. Correspondingly, before S820, the first device may determine the first threshold based on a service corresponding to the first device and the mapping relationship.

In some possible implementations, the first threshold may be preconfigured in the first device. Alternatively, the mapping relationship between the first threshold and a service may be preconfigured in the first device. Correspondingly, before S820, the first device may determine the first threshold based on a service corresponding to the first device and the mapping relationship.

In some possible implementations, the first threshold may be an access threshold corresponding to an AI of the first device. For example, the AI of the first device may be an AI value newly defined for a zero-power terminal device or for a specific service of the zero-power terminal device.

Optionally, it may also be specified in advance that the access threshold (corresponding to the AI of the first device) corresponds to allowing the first device to access a network or not allowing the first device to access a network.

For example, when the first device performs UAC, the first device is required to generate a normal distribution random number between 0 and 1, and then compare the random number with the access threshold to determine whether access to a network is allowed. In this case, it may be specified in advance that the access threshold is greater than 1, then the access threshold is surly greater than the random number generated by the first device, that is, the access threshold corresponds to allowing the first device to access a network. Alternatively, it may be specified in advance that the access threshold is equal to 0, the access threshold is surly less than the random number generated by the first device, that is, the access threshold corresponds to not allowing the first device to access a network.

When determining, based on the first threshold, whether the first device is allowed to access a network, the first device may generate a first random number. For example, the first device may generate a normal distribution random number between 0 and 1.

Subsequently, the first device may compare the first random number with the first threshold to determine whether access to a network is allowed. For example, if the first random number is less than the first threshold, the first device may determine that the first device is allowed to access the network; or if the first random number is greater than the first threshold, the first device may determine that the first device is allowed to access the network.

S830: When the first device is allowed to access the network, the first device transmits a response signal to the second device.

In a case that the first device is allowed to access the network, if the second device is a proxy terminal device, the second device may transmit the response signal to the network device, so that the network device processes the response signal, that is, performs a zero-power service. If the second device is a network device, the second device may process the response signal.

In other words, a zero-power terminal device may transmit the response signal only when being allowed to access a network. Correspondingly, the second device may process the response signal only when the zero-power terminal device is allowed to access a network.

In a case that the first device is not allowed to access the network, the first device may start a timer, and after the timer expires, initiate UAC again, for example, repeat the steps in the method 800.

In embodiments of this application, the first device determines, based on the first threshold, whether the first device is allowed to access a network, and when being allowed to access a network, the first device transmits the response signal of the trigger signal to the second device, thereby implementing access control of the zero-power terminal device.

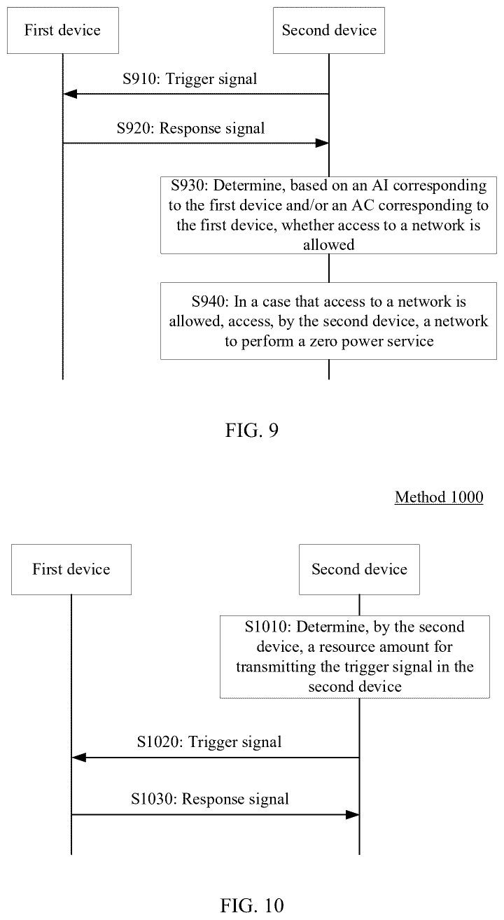

FIG. 9 is a schematic flowchart of a communication method according to an embodiment of this application. The method 900 shown in FIG. 9 may include steps S910 to S940.

Details are as follows.

S910: A second device transmits a trigger signal to a first device.

The first device may be a zero-power terminal device.

The second device may be a proxy terminal device. The first device may use the second device as a relay device, and access a network via the second device.

The second device may alternatively be a network device. For example, the second device may be an RAN, an AMF, a PCF, or the like in FIG. 6. The RAN in FIG. 6 may be an eNB, a gNB, a device that functions as a base station in a future communications system, or the like.

S920: The first device transmits a response signal to the second device.

S930. The second device determines, based on an AI corresponding to the first device and/or an AC corresponding to the first device, whether access to a network is allowed.

For example, the second device may determine a second threshold based on the AI corresponding to the first device and/or the AC corresponding to the first device. For example, the second threshold may be 0.3.

The second device may generate a second random number. The second random number may be a normal distributed random number between 0 and 1.

Subsequently, the second device may compare the second random number with the second threshold to determine whether access to a network is allowed. For example, if the second random number is less than the second threshold, the second device may determine that the first device is allowed to access a network; or if the second random number is greater than the second threshold, the second device may determine that the first device is allowed to access the network.

In embodiments of this application, the second device may acquire, in a plurality of manners, the AI corresponding to the first device and/or the AC corresponding to the first device.

In some possible implementations, the response signal transmitted by the first device to the second device in S920 may include the AI of the first device and/or the AC corresponding to the first device.

In some possible implementations, the AI corresponding to the first device may be preconfigured in the second device.

In some possible implementations, the AI corresponding to the first device may be an AI of the second device. For example, in S930, the second device may determine, based on the AI of the second device, whether access to a network is allowed. Because a priority of a zero-power terminal device is generally lower, and the second device is usually not a zero-power terminal device, by directly using the AI of the second device to determine whether access to a network is allowed, a success rate of accessing a network by the zero-power terminal device can be improved.

In some possible implementations, the AC corresponding to the first device may be for a zero power service. For example, the AC of the first device may be an AC value newly defined for a zero-power terminal device or for a specific service of the zero-power terminal device.

S940: In a case that access to the network is allowed, the second device performs a zero power service based on the response signal.

In a case that the first device is allowed to access the network, if the second device is a proxy terminal device and the second device is in a connected state, the second device may transmit the response signal to a network device, so that the network device processes the response signal, that is, performs a zero-power service. If the second device is a proxy terminal device and the second device is in an idle or inactive state, the second device may first access a network and then transmit the response signal to the network device, so that the network device processes the response signal.

In other words, the proxy terminal device may transmit the response signal to the network device only when the zero-power terminal device is allowed to access a network. Correspondingly, the network device may receive the response signal and process the response signal only when the zero-power terminal device is allowed to access a network.

If the second device is a network device, the second device may process the response signal when the first device is allowed to access a network. In other words, the network device may process the response signal only when the zero-power terminal device is allowed to access a network.

In a case that access to the network is not allowed, the second device may start a timer, and after the timer expires, trigger the first device to initiate UAC again, for example, repeat the steps in the method 900.

Optionally, the second device may alternatively transmit feedback information to the first device, to notify whether the first device is allowed to access a network. For example, the second device may transmit the feedback information to the first device via an RRC layer or an NAS layer.

In embodiments of this application, the second device determines, based on the AI corresponding to the first device and/or the AC corresponding to the first device, whether access to a network is allowed, and only when access to the network is allowed, the second device performs a zero-power service based on the response signal, thereby implementing access control of the zero-power terminal device.

FIG. 10 is a schematic flowchart of a communication method according to an embodiment of this application. The method 1000 shown in FIG. 10 may include steps S1010 to S1030. Details are as follows.

S1010: A second device determines an amount of resources allowed for transmitting a trigger signal among resources of the second device.

The second device may be a proxy terminal device. The first device may use the second device as a relay device, and access a network via the second device. The first device may be a zero-power terminal device.

The second device may alternatively be a network device. For example, the second device may be an RAN, an AMF, a PCF, or the like in FIG. 6. The RAN in FIG. 6 may be an eNB, a gNB, a device that functions as a base station in a future communications system, or the like.

The second device may determine, based on a first value, the amount of resources allowed for transmitting the trigger signal. Optionally, the second device may determine, based on the first value and an amount of available resources of the second device, the amount of resources allowed for transmitting the trigger signal. For example, the second device may multiply the amount of available resources of the second device by the first value to determine the amount of resources allowed for transmitting the trigger signal. The amount of available resources of the second device may include: a quantity of time domain resources in the second device, a quantity of frequency domain resources in the second device, a quantity of trigger signals allowed to be transmitted by the second device, available transmit power of the second device, and/or the like.

Optionally, the first value may be an access threshold. For example, the first value may be 0.3. Alternatively, the first value may be 1. In this case, it may indicate that the second device can transmit the trigger signal by using all available resources.

The amount of resources allowed for transmitting the trigger signal may include at least one of the following: a quantity of time domain resources, a quantity of frequency domain resources, a quantity of trigger signals allowed to be transmitted, or a transmit power for transmitting the trigger signal.

In embodiments of this application, the second device may obtain the first value in a plurality of manners.

In some possible implementations, the first value may be preconfigured in the second device.

In some possible implementations, the first value may be a random number. For example, the first value may be a normal distribution random number between 0 and 1 generated by the second device.

In some possible implementations, the first value may be determined based on configuration information transmitted by a core network (CN). For example, when the second device is a network device, the AMF may transmit the configuration information to the network device. When the second device is a proxy terminal device, the AMF or the PCF may transmit the configuration information to the proxy terminal device. Specifically, the AMF or the PCF may transmit a mapping relationship to the proxy terminal device via an NAS layer.

The configuration information may include the first value. Optionally, the first value may be for all services. For example, the first value may correspond to all services of the zero-power terminal device (In other words, for all services of the zero-power terminal device, values of the first threshold are the same).

The configuration information may include a mapping relationship between a first value and a service. For example, m first values may be in a one-to-one correspondence with the m services. The configuration information may include a correspondence between the m first values (the m first values may be m access thresholds) and the m services, where m is a positive integer.

Optionally, before obtaining the configuration information, the second device may first transmit request information to the core network, to request the core network to transmit the configuration information. For example, when the second device is a proxy terminal device, the second device may request, through a registration accept message or a configuration update command, the core network to transmit the configuration information.

Correspondingly, before S1010, the second device may determine the first value based on a service corresponding to the first device and the mapping relationship.

S1020: The second device transmits the trigger signal based on the amount of resources.

The second device transmits the trigger signal based on the determined quantity of time domain resources, the determined quantity of frequency domain resources, the determined quantity of trigger signals allowed to be transmitted, and/or the determined transmit power for transmitting the trigger signal, so that some zero-power terminal devices (for example, part of zero-power terminal devices within coverage of the second device) receive the trigger signal. For example, the amount of resources determined in S1010 may include K trigger signals. In this case, the second device in S1020 may transmit K trigger signals to a specific direction, so that K zero-power terminal devices receive the K trigger signals, where K is a positive integer. Correspondingly, the second device may receive only K response signals. In this way, a quantity of zero-power terminal devices accessing a network can be controlled, thereby implementing access control of the zero-power terminal devices.

S1030: The second device receives a response signal transmitted by the first device.

If the second device is a proxy terminal device, the second device may transmit the response signal to the network device, so that the network device processes the response signal, that is, performs a zero-power service. If the second device is a network device, the second device may process the response signal.

The first device may be one of zero-power terminal devices that receive the trigger signal transmitted by the second device in S1020.

In embodiments of this application, the second device determines the amount of resources allowed for transmitting the trigger signal, and transmits the trigger signal based on the determined amount of resources, and thus part of zero-power terminal devices make a response, thereby implementing access control of a zero-power terminal device.

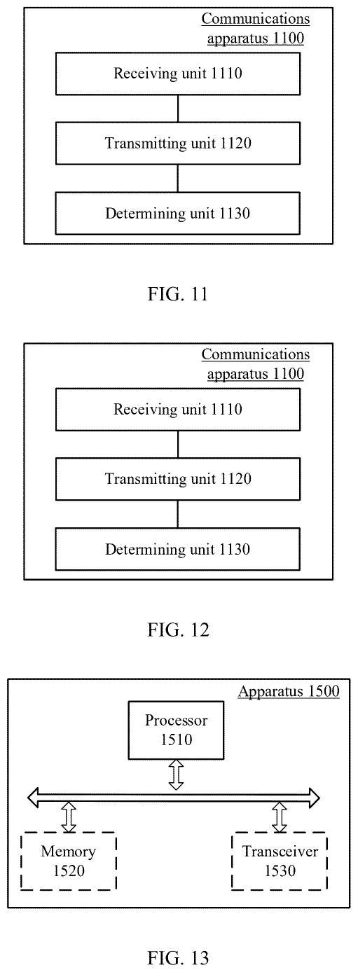

The method embodiments of this application are described in detail above with reference to FIG. 1 to FIG. 10. Apparatus embodiments of this application are described in detail below with reference to FIG. 11 to FIG. 13. It should be understood that the description of the method embodiments corresponds to the description of the apparatus embodiments, and therefore, for parts that are not described in detail, reference may be made to the foregoing method embodiments.

FIG. 11 is a schematic structural diagram of a communications apparatus according to an embodiment of this application. A communications apparatus 1100 in FIG. 11 includes a receiving unit 1110 and a transmitting unit 1120. Details are as follows.

The receiving unit 1110 is configured to receive a trigger signal transmitted by a second device.

The transmitting unit 1120 is configured to transmit a response signal to the trigger signal to the second device.

The apparatus is a zero-power terminal device, and the second device is a network device or a proxy terminal device.

Optionally, the apparatus 1100 further includes a determining unit 1130, configured to determine, based on a first threshold, whether the apparatus is allowed to access a network. The transmitting unit 1120 is configured to: in a case that the apparatus is allowed to access the network, transmit the response signal to the second device.

Optionally, the first threshold is preconfigured in the apparatus, or the first threshold is an access threshold corresponding to an access identity AI of the apparatus.

Optionally, the first threshold is determined based on the trigger signal.

Optionally, the trigger signal includes the first threshold; or the trigger signal includes a mapping relationship between the first threshold and a service, and before determining, based on the first threshold, whether the apparatus is allowed to access the network, the determining unit 1130 is further configured to determine the first threshold based on a service corresponding to the apparatus and the mapping relationship.

Optionally, the first threshold is determined based on broadcast information, and before determining, based on the first threshold, whether the apparatus is allowed to access the network, the receiving unit 1110 is further configured to receive the broadcast information transmitted by the second device.

Optionally, the determining unit 1130 is specifically configured to: generate a first random number; and in a case that the first random number is less than the first threshold, determine that the apparatus is allowed to access a network; or in a case that the first random number is greater than the first threshold, determine that the apparatus is allowed to access a network.

Optionally, the response signal includes an access identity AI of the apparatus and/or an access category AC corresponding to the apparatus.

FIG. 12 is a schematic structural diagram of a communications apparatus according to an embodiment of this application. As shown in FIG. 12, the apparatus 1200 includes a transmitting unit 1210 and a receiving unit 1220. Details are as follows.

The transmitting unit 1210 is configured to transmit a trigger signal.

The receiving unit 1220 is configured to receive a response signal to the trigger signal transmitted by a first device.

The first device is a zero-power terminal device, and the apparatus is a network device or a proxy terminal device.

Optionally, the trigger signal includes a first threshold, or the trigger signal includes a mapping relationship between the first threshold and a service.

Optionally, the transmitting unit 1210 is further configured to transmit broadcast information to the first device, where the broadcast information includes a first threshold, or the broadcast information includes a mapping relationship between the first threshold and a service.

Optionally, the apparatus 1200 is a proxy terminal device, and the apparatus 1200 further includes a determining unit 1230 and a processing unit 1240. After the response signal to the trigger signal transmitted by the first device is received, the determining unit 1230 is configured to: determine, based on an access identity AI corresponding to the first device and/or an access category AC corresponding to the first device, whether access to a network is allowed. The processing unit 1240 is configured to: in a case that access to the network is allowed, perform a zero power service based on the response signal.

Optionally, the response signal includes an AI corresponding to the first device and/or an AC corresponding to the first device.

Optionally, the AI corresponding to the first device is preconfigured in the apparatus, or the AI corresponding to the first device is an AI of the apparatus.

Optionally, the AC corresponding to the first device is for a zero-power service.

Optionally, the determining unit 1230 is specifically configured to: determine a second threshold based on the AI corresponding to the first device and/or the AC corresponding to the first device; generate a second random number; and in a case that the second random number is less than the second threshold, determine that access to a network is allowed; or in a case that the second random number is greater than the second threshold, determine that access to a network is allowed.

Optionally, the apparatus 1200 further includes a determining unit 1230, configured to determine an amount of resources allowed for transmitting the trigger signal among resources of the apparatus. The transmitting unit 1210 is specifically configured to transmit the trigger signal based on the amount of resources.

Optionally, the determining unit 1230 is specifically configured to determine the amount of resources based on a first value and an amount of available resources of the apparatus.

Optionally, the first value is preconfigured in the apparatus, or the first value is a random number.

Optionally, the first value is determined based on configuration information transmitted by a core network.

Optionally, the configuration information includes the first value, or the configuration information includes a mapping relationship between the first value and a service. Before determining the amount of resources based on the first value and the amount of available resources of the apparatus, the determining unit 1230 is further configured to determine the first value based on the service corresponding to the first device and the mapping relationship.

Optionally, the amount of resources includes at least one of the following: a quantity of time domain resources, a quantity of frequency domain resources, a quantity of trigger signals allowed to be transmitted, or a transmit power for transmitting the trigger signal.

FIG. 13 is a schematic structural diagram of an apparatus according to an embodiment of this application. A dashed line in FIG. 13 indicates that the unit or module is optional. The apparatus 1300 may be configured to implement the methods described in the foregoing method embodiments. The apparatus 1300 may be a chip or a communications apparatus.

The apparatus 1300 may include one or more processors 1310. The processor 1310 may allow the apparatus 1300 to implement the methods described in the foregoing method embodiments. The processor 1310 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1300 may further include one or more memories 1320. The memory 1320 stores a program, where the program may be executed by the processor 1310, to cause the processor 1310 to perform the methods described in the foregoing method embodiments. The memory 1320 may be independent of or integrated into the processor 1310.

The apparatus 1300 may further include a transceiver 1330. The processor 1310 may communicate with another device or chip by using the transceiver 1330. For example, the processor 1310 may transmit data to and receive data from another device or chip by using the transceiver 1330.

An embodiment of this application further provides a computer-readable storage medium, configured to store a program. The computer-readable storage medium may be applied to a communications apparatus provided in embodiments of this application, and the program causes a computer to execute the methods executed by the communications apparatus in various embodiments of this application.

An embodiment of this application further provides a computer program product. The computer program product includes a program. The computer program product may be applied to a communications apparatus provided in embodiments of this application, and the program causes a computer to execute the methods executed by the communications apparatus in various embodiments of this application.

An embodiment of this application further provides a computer program. The computer program may be applied to a communications apparatus provided in embodiments of this application, and the computer program causes a computer to execute the methods executed by the communications apparatus in various embodiments of this application.

It should be understood that, in embodiments of this application, “B corresponding to A” means that B is associated with A, and B may be determined based on A. However, it should be further understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via a wired (such as a coaxial cable, an optical fiber, or a digital subscriber line (DSL)) manner or a wireless (such as infrared, wireless, or microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A communication apparatus, wherein the communication apparatus is a first device comprising a processor configured to perform operations of:
receiving a trigger signal transmitted by a second device; and
transmitting a response signal to the trigger signal to the second device, wherein
the first device is a zero-power terminal device, and the second device is a network device or a proxy terminal device.

2. The communication apparatus according to claim 1, wherein the processor is further configured to perform operations of:
determining, based on a first threshold, whether the first device is allowed to access a network; and
in a case that the first device is allowed to access the network, transmitting the response signal to the second device.

3. The communication apparatus according to claim 2, wherein the first threshold is preconfigured in the first device, or the first threshold is an access threshold corresponding to an access identity (AI) of the first device.

4. The communication apparatus according to claim 2, wherein the first threshold is determined based on the trigger signal.

5. The communication apparatus according to claim 4, wherein the trigger signal comprises the first threshold; or the trigger signal comprises a mapping relationship between the first threshold and a service, and the processor is configured to perform an operation of:
determining the first threshold based on a service corresponding to the first device and the mapping relationship.

6. The communication apparatus according to claim 2, wherein the first threshold is determined based on broadcast information, and the processor is configured to perform an operation of:
receiving the broadcast information transmitted by the second device.

7. The communication apparatus according to claim 2, wherein the processor is configured to perform operations of:
generating a first random number; and
in a case that the first random number is less than the first threshold, determining that the first device is allowed to access the network; or
in a case that the first random number is greater than the first threshold, determining that the first device is allowed to access the network.

8. A communication apparatus, wherein the communication apparatus is a second device comprising a processor configured to perform operations of:
transmitting a trigger signal; and
receiving a response signal to the trigger signal transmitted by a first device, wherein
the first device is a zero-power terminal device, and the second device is a network device or a proxy terminal device.

9. The communication apparatus according to claim 8, wherein the trigger signal comprises a first threshold, or the trigger signal comprises a mapping relationship between the first threshold and a service.

10. The communication apparatus according to claim 8, wherein the processor is configured to perform an operation of:
transmitting broadcast information to the first device, wherein the broadcast information comprises a first threshold, or the broadcast information comprises a mapping relationship between a first threshold and a service.

11. The communication apparatus according to claim 8, wherein the second device is a proxy terminal device, and the processor is configured to perform operations of:
determining, based on an access identity (AI) corresponding to the first device and/or an access category (AC) corresponding to the first device, whether the first device is allowed to access to a network; and
in a case that the first device is allowed to access to the network, performing a zero power service based on the response signal.

12. The communication apparatus according to claim 11, wherein the AI corresponding to the first device is preconfigured in the second device, or the AI corresponding to the first device is an AI of the second device.

13. The communication apparatus according to claim 11, wherein the AC corresponding to the first device is for a zero power service.

14. The communication apparatus according to claim 11, wherein the processor is configured to perform operations of:
determining a second threshold based on the AI corresponding to the first device and/or the AC corresponding to the first device;
generating a second random number; and
in a case that the second random number is less than the second threshold, determining that the first device is allowed to access to the network; or
in a case that the second random number is greater than the second threshold, determining that the first device is allowed to access to the network.

15. The communication apparatus according to claim 8, wherein the processor is configured to perform operations of:
determining an amount of resources allowed for transmitting the trigger signal among resources of the second device; and
transmitting the trigger signal based on the amount of resources.

16. The communication apparatus according to claim 15, wherein the processor is configured to perform an operation of:
determining the amount of resources based on a first value and an amount of available resources of the second device.

17. The communication apparatus according to claim 16, wherein the first value is preconfigured in the second device, or the first value is a random number.

18. The communication apparatus according to claim 16, wherein the first value is determined based on configuration information transmitted by a core network.

19. The communication apparatus according to claim 18, wherein the configuration information comprises the first value; or the configuration information comprises a mapping relationship between the first value and a service, and the processor is configured to perform an operation of:
determining the first value based on a service corresponding to the first device and the mapping relationship.

20. The communication apparatus according to claim 15, wherein the amount of resources comprises at least one of following:
a quantity of time domain resources, a quantity of frequency domain resources, a quantity of trigger signals allowed to be transmitted, or a transmit power for transmitting the trigger signal.
